(19) United States
(12) Patent Application Publication
(10) Pub. No.: US 2014/0226688 A1
(43) Pub. Date: Aug. 14, 2014

(54) MULTIPLE OUTPUT DIODE DRIVER WITH INDEPENDENT CURRENT CONTROL AND OUTPUT CURRENT MODULATION

(71) Applicant: RAYTHEON COMPANY, Waltham, MA (US)

(72) Inventor: Joe A. Ortiz, Garden Grove, CA (US)

(73) Assignee: Raytheon Company, Waltham, MA (US)

(21) Appl. No.: 13/764,409

(22) Filed: Feb. 11, 2013

(51) Int. Cl. H01S 3/09

(52) U.S. Cl. CPC H01S 3/09
USPC 372/38.02

(57) ABSTRACT

The present technology provides a multiple output diode driver that includes a high side current source and at least two loads electrically coupled in series to the current source, each respective load including at least one laser diode. The multiple output diode driver can further include a shunt device electrically coupled in parallel with at least one of the at least two loads to reduce the DC pump current to its respective load. The shunt device can be a load element, a switching device, or any series coupled combination thereof.

### BACKGROUND

Diode pumping has become the technique of choice for use as pump sources employed in solid-state laser systems due to their relatively high electrical-to-optical efficiency. Prior to the use of diode pumping, flashlamps were used as pump sources. Typical system efficiencies were in the 1% to 2% range. The low efficiency was due mainly to the low electrical-to-optical efficiency. The use of diode pumping, with its higher electrical-to-optical efficiency, can result in a laser system efficiency of 10%, to 15%. Thus, a tenfold reduction in required input power can be achieved.

Diode pumping requires high power regulated current sources to drive the pump diodes. Conventional current sources utilize either a series dissipative regulator or a pulse-width-modulated (PWM) converter to control output current. Each gain stage of a multiple-stage diode pumped solid state laser requires its own independently-controlled diode pump current to its pump diodes. As a result, each gain stage of a multiple-stage diode pumped solid state laser requires its own diode driver, resulting in multiple diode drivers for a laser system. The use of a separate diode driver for each gain stage adds volume, mass, and cost to the laser system.

As space requirements become more and more the norm, a current source that can drive multiple loads is advantageous. The applicant of the present application has previously developed a current source capable of driving multiple loads that is disclosed in U.S. Pat. No. 5,736,881, entitled “Diode Drive Current Source”, the entirety is herein incorporated by reference, that utilizes a regulated constant power source to supply current to drive a load, and the load current is controlled by shunt switches. However, in this configuration, the current source can only drive one load at a time and does not combine the functions of multiple diode drivers into a single diode driver.

### SUMMARY

Therefore, a need exists to combine the functions of multiple diode drivers into a single diode driver that can control multiple loads at the same time. In one embodiment, a multiple output diode driver includes a high side current source and at least two loads electrically coupled in series to the current source, each respective load including at least one laser diode. The multiple output diode driver can further include a shunt device electrically coupled in parallel with at least one of the at least two loads to reduce the DC pump current to its respective load. The shunt device can be a load element, a switching device, or any series coupled combination thereof. The current source can be a linear driver or a switching converter driver.

In one embodiment, the shunting device can be electrically coupled in parallel with at least one of the at least two loads to allow the shunt current to be switched as a function of time or operating condition. In another embodiment, at least two combined shunting devices can be electrically coupled in parallel with each other and with at least one of the at least two loads to provide a variable shunt current, where the current is variable as a function of time or operating condition.

In one embodiment, the load element can be a resistor. In one embodiment, the switching device can be a transistor.

In yet one embodiment, the shunt current can be duty cycle modulated for at least one of the at least two loads.

In one embodiment, the shunt device can be a controlled current sink to allow the shunt current to be sensed and regulated to a value determined by a command variable. In yet another embodiment, the shunt device can be a controlled current sink to allow the diode current to be sensed and regulated to a value determined by a command variable.

In another embodiment, multiple output diode driver can further include a switching device electrically coupled in series with at least one of the at least two loads to allow the current to be switched from its respective load to the load of the shunting device.

The foregoing embodiments provide the following advantages over prior art diode drivers. 1) a single diode driver to drive multiple loads, and particularly laser diodes, that require multiple driver configurations; 2) reduced complexity, cost, volume, and mass; 3) in many cases, improved reliability, and improved efficiency.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 shows a multiple output diode driver that drives two loads at the same DC drive current;

FIG. 2 shows a multiple output diode driver that drives two loads but at a different DC drive current;

FIG. 3 shows a variation of the multiple output diode driver of FIG. 2, where the shunt current can be switched on or off as a function of time;

FIG. 4 shows another variation of the multiple output diode driver of FIG. 2, where the value of the shunt current can be changed by switching shunt resistors in or out, changing the net value of the shunt resistance;

FIG. 5 shows another variation of the multiple output diode driver of FIG. 2, where the shunt current is sensed and regulated to a value determined by a command variable;

FIG. 6 shows a variation of the multiple output diode driver of FIG. 5, where the pump diode current is sensed and regulated to a value determined by a command variable;

FIG. 7 shows a variation of the multiple output diode driver of FIG. 2, where the same DC drive current is used for a time t for both diodes and the drive current to one of the diodes is shunted for the reminder of the time period;

FIG. 8 shows a variation of the multiple output diode driver of FIG. 3, where the same DC drive current is used for a time t for both diodes and then switches the drive current from one of the diodes to a dummy load for the reminder of the time period;

FIG. 9 shows a variation of the multiple output diode driver of FIG. 8;

FIG. 10 shows a variation of the multiple output diode driver of FIG. 3, where the top load is shunted;

FIG. 11 shows a variation of the multiple output diode driver of FIG. 3, where either load can be shunted; and

FIG. 12 shows a variation of the multiple output diode driver of FIG. 7, where either load can be shorted.

### DETAILED DESCRIPTION

A laser diode driver, in the most ideal form, is a constant current source, linear, noiseless, and accurate, that delivers exactly the current to the laser diode that it needs to operate for a particular application. In this configuration, one laser diode driver is used per load, such as a laser diode array that includes a varying number of light emitting diodes. However, as laser technology progresses to smaller and smaller footprints, a premium is placed on space, volume, and mass requirements for all laser components, including the laser diode driver. The present technology addresses these needs by providing a multiple output diode driver that in some configurations combines the functionality of multiple diode drivers, thereby eliminating the need for a one-to-one laser diode driver per load.

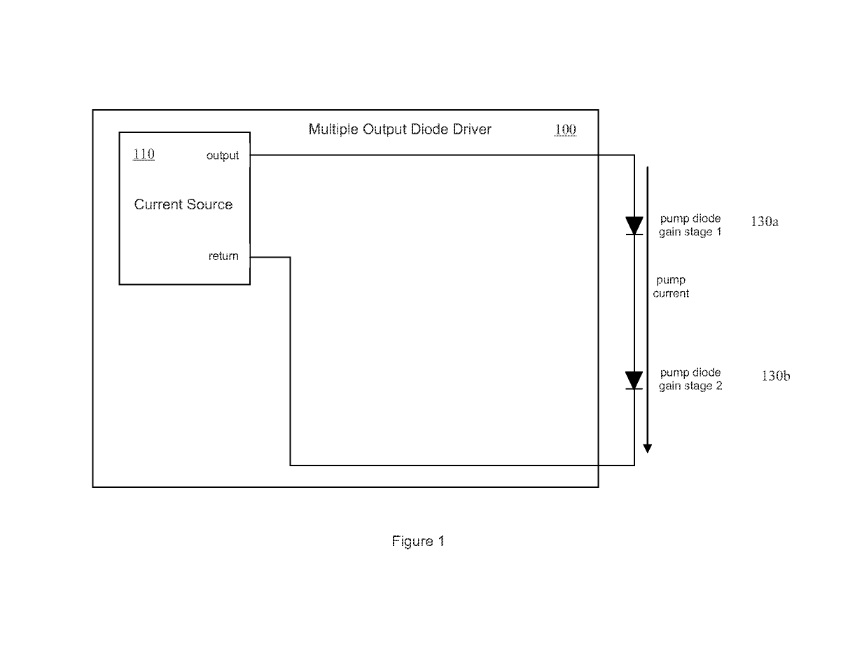

FIG. 1 shows a multiple output diode driver that drives two loads at the same DC drive current. In one embodiment, the diode driver 100 includes a high side current source 110 to drive two series connected loads 130a, 130b at the same DC drive current, such as a laser diode, laser diodes, or laser diode arrays that have a varying number of light emitting diodes therein. For example, a single diode driver 100 can drive the pump diodes 130a for a preamplifier gain stage as well as drive the pump diodes 130b for a master oscillator gain stage at the same time. In this configuration, the efficiency is improved since diode driver parasitic voltage losses are a smaller percentage of the output voltage, and diode driver parasitic power losses are a smaller percentage of the output power. The high-side-drive current source 110 provides regulated output current rather than low-side drive current sinks thereby protecting the pump diodes 130a, 130b against over current conditions. For example, utilizing a high-side-drive current source 110, the pump diodes 130a, a30b can be directly shorted (shunted) to ground anywhere in the diode string with no uncontrolled diode current to the pump diodes, whereas utilizing a low-side drive current sink, a short from the diode cathode to ground will cause unlimited current to flow in the diodes until the capacitor discharges and will damage the pump diodes 130a, 130b.

Although the technology describes two series connected loads 130a, 130b, it should be understood the technology is not limited in this regard, but can be any of a plurality of series connected loads. It should be understood that the pump current is not limited to DC current, but can be pulsed current, or any other current capable of driving two series coupled loads.

In one embodiment, the current source 110 can be a zero-current-switched quasi-resonant buck converter to improve overall diode driver efficiency. However, it should be understood that any linear current source diode driver, hard-switched converter current source, or a soft-switched converter current source, irrespective of topology, can be used with the present technology. A detailed description of the quasi-resonant current source is provided in U.S. Pat. No. 5,287,372; entitled “Quasi-Resonant Diode Drive Current Source”, the contents of which are herein incorporated by reference.

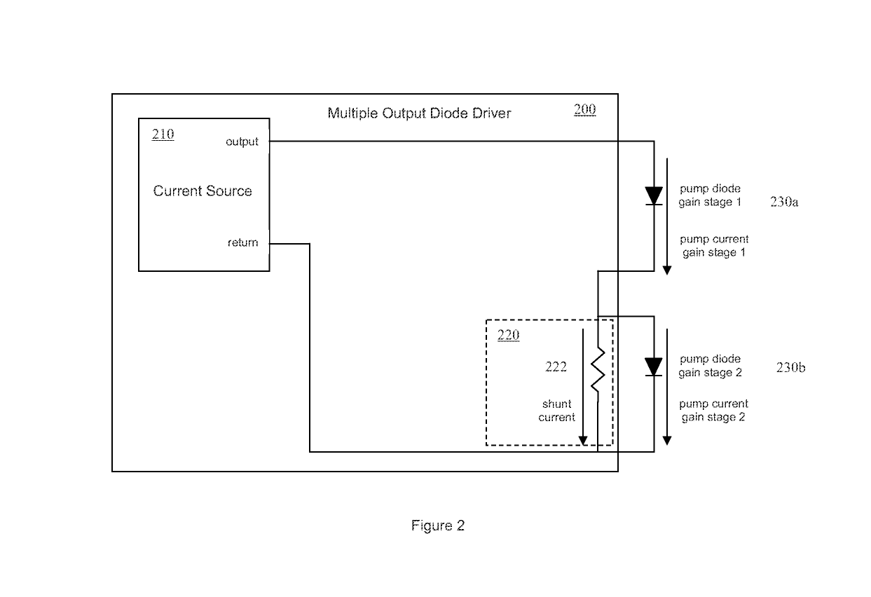

FIGS. 2-9 show a multiple output diode driver that drives two loads, but at a different DC drive current. In these embodiments, the multiple output diode driver 200 includes a current source 210 and a shunt device 220. The shunt device 220 is coupled in parallel with the pump diode 230b of gain stage 2 to reduce the pump diode current and provide two different drive currents for laser optimization. However, it should be understood that the reduced pump diode current can be supplied to either of the pump diode 230b of gain stage 2 or the pump diode 230a of gain stage 1, singularly or in combination.

As shown in FIG. 2, the shunt device 220 is fixed resistor 222. In this embodiment, the shunt current is a fixed current set by the forward voltage (VF) drop across the pump diode 230b and the resistance of the resistor 222. It should be understood that in this embodiment the shunt current cannot be changed once set.

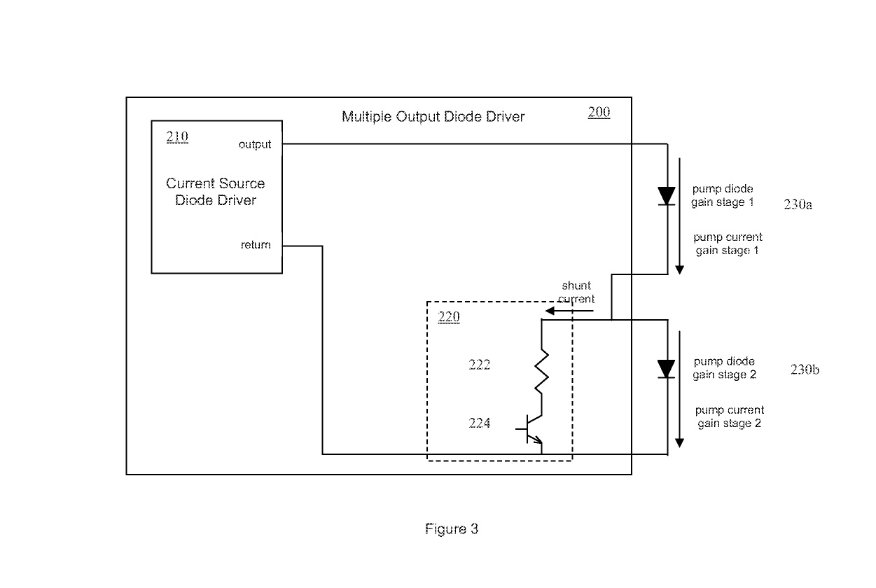

FIG. 3 shows a variation of the multiple output diode driver of FIG. 2, where the shunt current can be switched on or off as a function of time or operating condition. In this embodiment, the shunt device 220 includes a resistor 222 coupled in series with a switching device 224. Similar to the embodiment of FIG. 2, the shunt current is a fixed current set by the forward voltage (VF) drop across the pump diode 230b and the resistance of the resistor 222, but can be switched on and off as a function of time or operating condition. In this embodiment, the switching device 224 is a transistor, but it should be understood that the switching device can be any device known that can switch the shunt current on and off as a function of time or operating condition.

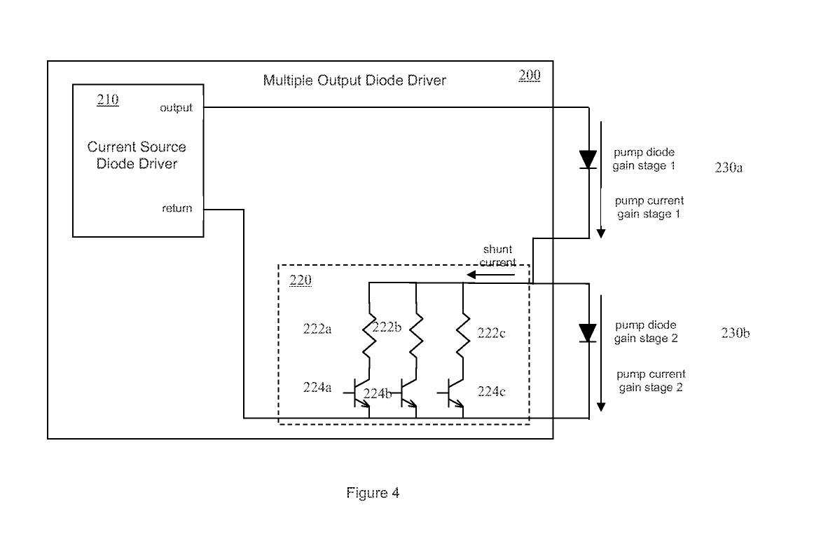

FIG. 4 shows another variation of the multiple output diode driver of FIG. 2, where the value of the shunt current can be changed by changing the value of the resistance across the load. In this embodiment, the shunt device includes multiple switched shunting devices 222a/224a, 222b/224b, 222c/224c that are coupled in parallel with the with the pump diode 230b of gain stage 2 to reduce the pump diode current and provide two different drive currents for laser optimization. In this embodiment, the shunt current is a variable current set by the forward voltage (VF) drop across the pump diode 230b and the resistance of the enabled multiple switched shunting devices 222a/224a, 222b/224b, 222c/224c. In this configuration, the value of the resistance of the paralleled resistors can be changed which in turn changes the shunt current. It should be understood that the resistors in this configuration can have the same or different values.

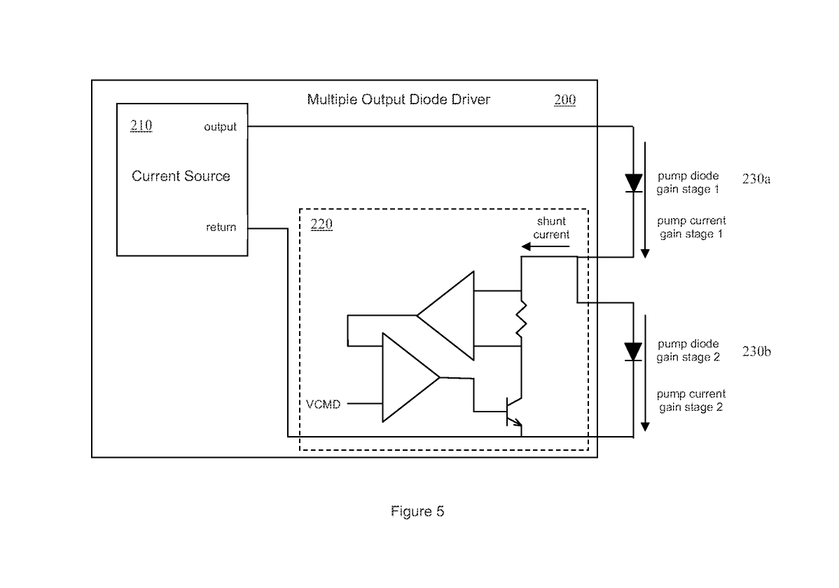

FIG. 5 shows another variation of the multiple output diode driver of FIG. 2. In this embodiment, the shunt device 220 is a controlled current sink where the shunt current is sensed and regulated to a value determined by a command variable (VCMD) coupled to the laser control electronics (not shown), and the shunt current may be independent of the forward voltage (VF) drop across the pump diode 230b. In this configuration, the shunt current can be set to any value within a given range. It should be understood that the circuit shown for the shunt device 220 is representative of a current sink regulator; the technology is not limited in this respect.

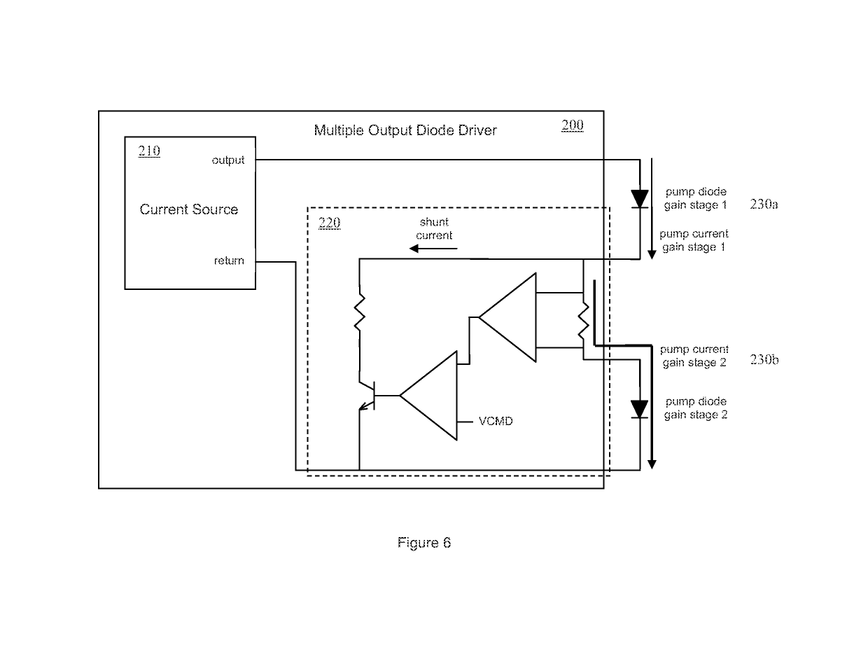

FIG. 6 shows a variation of the multiple output diode driver of FIG. 5. In this embodiment, the shunt device 220 is a controlled current sink where the pump diode current is sensed and regulated to a value determined by a command variable (VCMD) coupled to the laser control electronics (not shown), and the pump current may be independent of the forward voltage (VF) drop across the pump diode 230b. In this configuration, the shunt current can be set to any value within a given range.

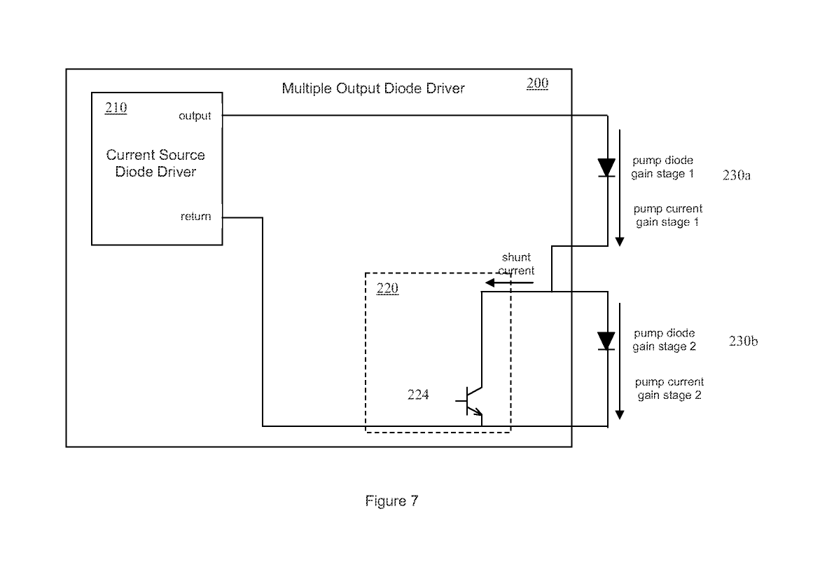

FIG. 7 shows a variation of the multiple output diode driver of FIG. 2, where the same DC drive current is used for a time t for both pump diodes and the drive current to one of the diodes is shunted for the reminder of the time period. In one embodiment, the shunt device 220 is a switching device 224, such as a transistor, coupled in parallel with the pump diode 230b of gain stage 2 that essentially duty cycle modulates the shunt current of the pump diode 230b for laser optimization. In operation, the shunt device 220 switches off the drive current by shunting the current from the pump diode 230b and the power dissipated in the shunt device 220 approaches zero since the voltage across the shunt device 220 is close to zero volts. During the time both pump diodes 230a, 230b are driven, the output power is 2*VF*IF, where VF is the forward voltage of the pump diodes, IF is the pump current, and the input power is (2*VF*IF)/efficiency. In this embodiment, the two pumped diodes 230a, 230b are matched, but it should be understood that matching is not required for use with the technology. During the time the pump diode 230b is shunted, the output power is VF*IF, where VF is the forward voltage of the pump diode 230a, IF is the pump current, and the input power is (VF*IF)/efficiency. Note, that in this mode of operation, the input power changes from (2*VF*IF)/efficiency to (VF*IF)/efficiency, a change of 2:1. Thus, there is virtually no penalty in power dissipated with this diode driver configuration.

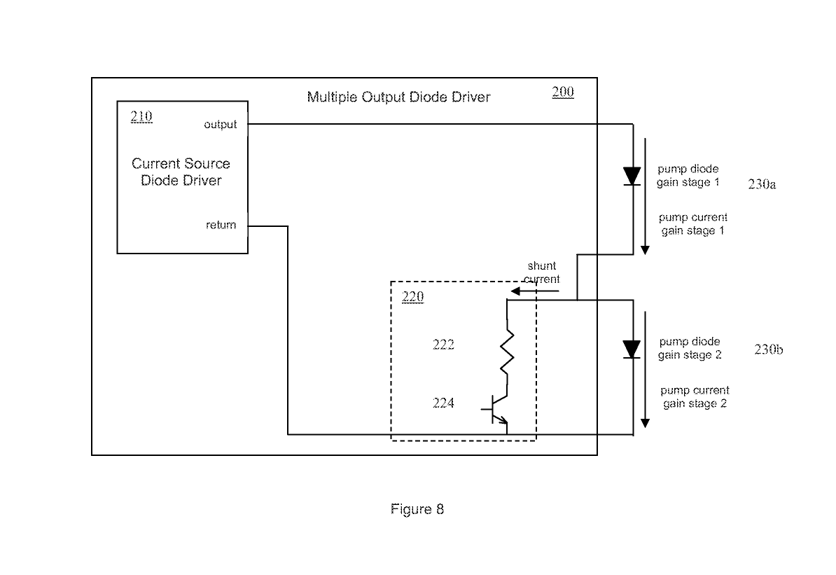

FIG. 8 shows a variation of the multiple output diode driver of FIG. 3, where the same DC drive current is used for a time t for both pump diodes and the drive current is switched from one of the pump diodes to a dummy load for the reminder of the time period. In this embodiment, the shunt device 220 includes a resistor 222 (dummy load) coupled in series with a switching device 224, where the value of the resistor 222 is selected such that all the current is shunted away from the pump diode 230b. Note, if the power dissipated in the resistor 222 (dummy load) matches the power dissipated in the pump diode 230b, the output power of the diode driver 200 does not change, and thus the input power to the diode driver 200 does not change. Thus, the modulation of the pump current is not reflected back to the power source as conducted emissions.

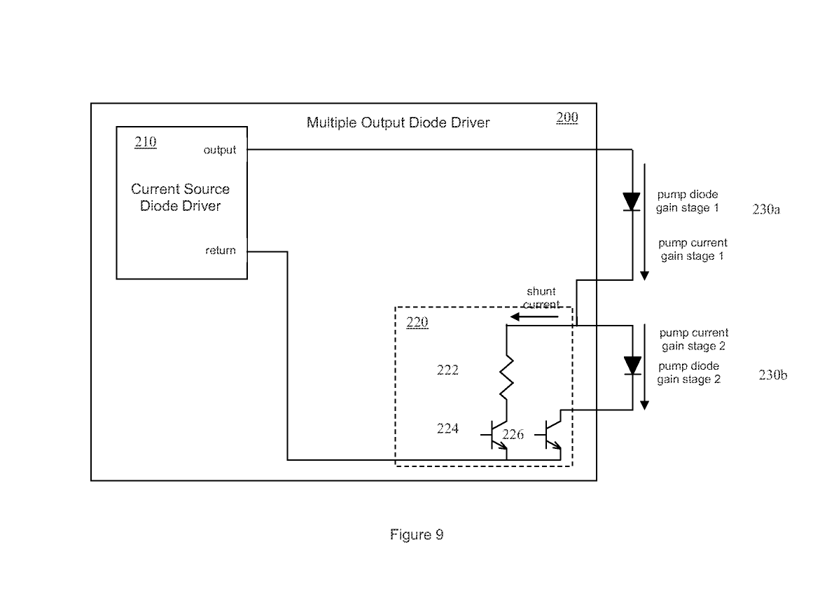

FIG. 9 shows a variation of the multiple output diode driver of FIG. 8. In this embodiment, the shunt device 220 includes an additional transistor 226 to ensure the pump diode current is switched to zero at the time the shunt switch 224 is turned on.

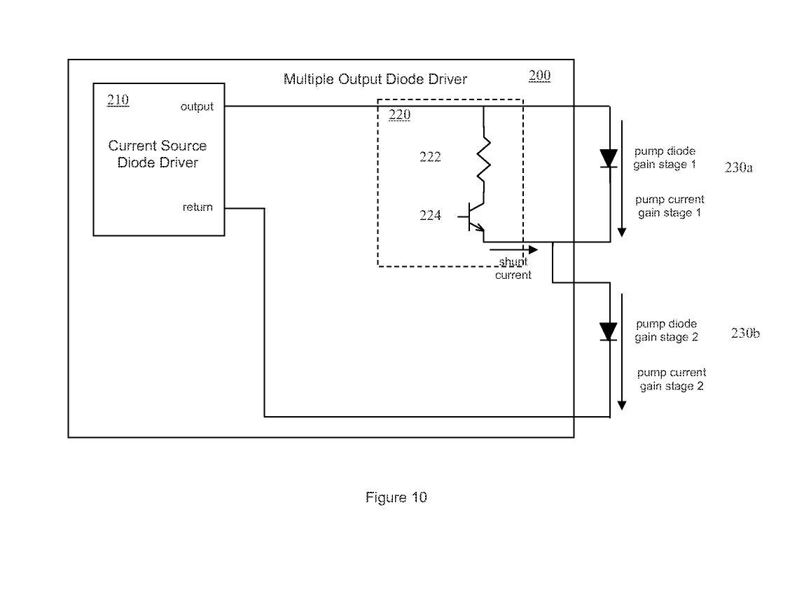

FIG. 10 shows a variation of the multiple output diode driver of FIG. 3. In this embodiment, the shunt device 200 includes a resistor 222 coupled in series with a switching device 224, however the shunt device 220 is coupled in parallel with the pump diode 230a of gain stage 1 to reduce the pump diode current and provide two different drive currents for laser optimization. The shunt current is a fixed current set by the forward voltage (VF) drop across the pump diode 230a and the resistance of the resistor 222, but can be switched on and off as a function of time or operating condition.

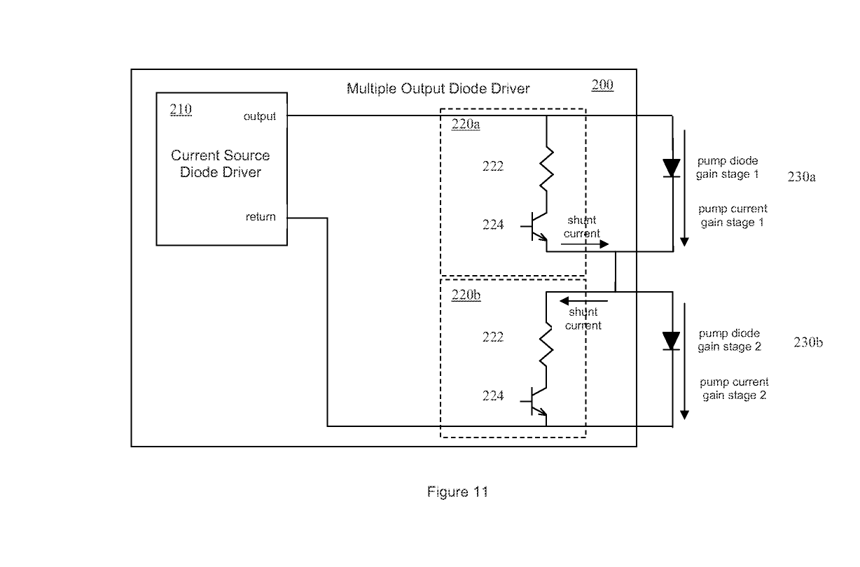

FIG. 11 shows a variation of the multiple output diode driver of FIG. 3. In this embodiment, a first shunt device 220a is coupled in parallel with the pump diode 230a of gain stage 1 and a second shunt device 220b is coupled in parallel with the pump diode 230b of gain stage 2. In this configuration, the shunt current can be switched across gain stage 1, gain stage 2, or a combination thereof.

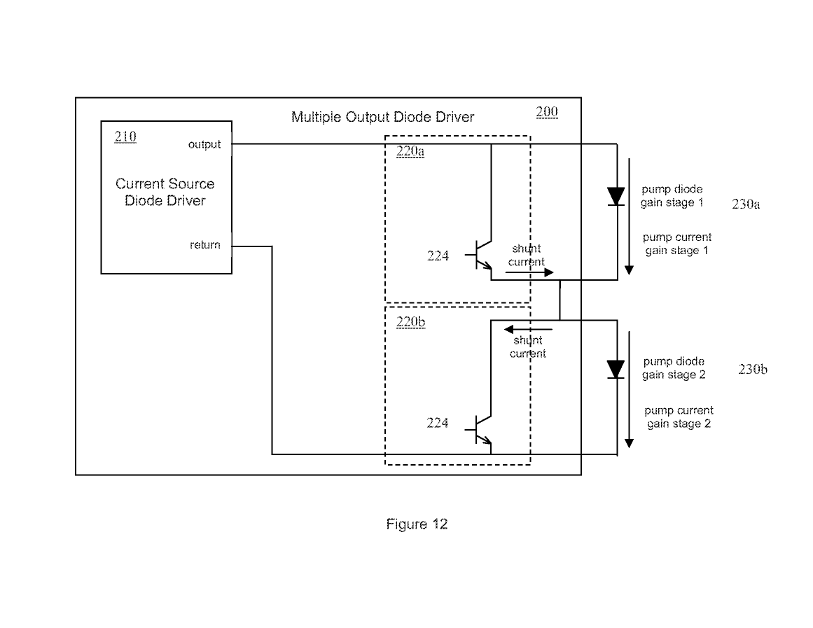

FIG. 12 shows a variation of the multiple output diode driver of FIG. 7. In this embodiment, a first shunt device 220a includes a switch 224a, such as a transistor, that is coupled in parallel with the pump diode 230a of gain stage 1 and a second shunt device 220b includes a switch 224b, such as a transistor, that is coupled in parallel with the pump diode 230b of gain stage 2. In this configuration, the pump current can be shunted across pump diode 230a, pump diode 230b, or a combination thereof.

Resistors are drawn, depicted, and discussed as the shunt elements, however, the technology can be implemented using any sort of passive or active load elements; the technology is not limited. NPN bipolar transistors and simplified regulation circuits are shown here, however, the technology can be implemented using any of many different semiconductors, ICs, and regulation circuits; the technology is not limited.

As discussed above, there are several possible variations of this technology. In some laser configurations, equal current to multiple gain stages is acceptable, and no additional current control is required. In other laser configurations, pump diode drive current requirements for one gain stage may be different than those for another gain stage. In other laser configurations, pump diode drive current may be duty cycle modulated. For these last two configurations, additional current control is added to the diode driver. However, this additional current control is significantly less circuitry than another whole diode driver. It should be understood that any of the above mentioned embodiments can be combined into one driver. Further, it should be understood that any other known driver configuration not discussed herein can be adapeted to the current technology. In some embodiments, the technology utilizes an active line filter to charge the energy storage capacitor to regulate and minimize input current and reduce component stress.

One skilled in the art will realize the technology may be embodied in other specific forms without departing from the spirit or essential characteristics thereof. The foregoing embodiments are therefore to be considered in all respects illustrative rather than limiting of the technology described herein. Scope of the technology is thus indicated by the appended claims, rather than by the foregoing description, and all changes that come within the meaning and range of equivalency of the claims are therefore intended to be embraced therein.

What is claimed is:

1. A multiple output diode driver, comprising:
a high side drive current source; and
at least two loads electrically coupled in series to the current source, each respective load including at least one laser diode.

2. The multiple output diode driver of claim 1, further comprising a shunt device electrically coupled in parallel with at least one of the at least two loads to reduce the DC pump current to its respective load.

3. The multiple output diode driver of claim 2, wherein the shunt device is a load element, a switching device, or any series coupled combination thereof.

4. The multiple output diode driver of claim 3, wherein at least one combined shunting device is electrically coupled in parallel with at least one of the at least two loads to allow the shunt current to be switched as a function of time or operating condition.

5. The multiple output diode driver of claim 3, wherein at least two combined shunting devices are electrically coupled in parallel with each other and with at least one of the at least two loads to provide a variable shunt current, where the current is variable as a function of time or operating condition.

6. The multiple output diode driver of claim 3, wherein the load element is a resistor.

7. The multiple output diode driver of claim 3, wherein the switching device is a transistor.

8. The multiple output diode driver of claim 3, wherein the shunt current is duty cycle modulated for at least one of the at least two loads.

9. The multiple output diode driver of claim 3, wherein the shunt device is a controlled current sink to allow the shunt current to be sensed and regulated to a value determined by a command variable.

10. The multiple output diode driver of claim 3, wherein the shunt device is a controlled current sink to allow the diode current to be sensed and regulated to a value determined by a command variable.

11. The multiple output diode driver of claim 2, further comprising a switching device electrically coupled in series with at least one of the at least two loads to allow the current to be switched from its respective load to the load of the shunting device.

12. The multiple output diode driver of claim 1, wherein current source is a linear driver or a switching converter driver.
